(19) United States
(12) Patent Application Publication
(10) Pub. No.: US 2023/0114310 A1
(43) Pub. Date: Apr. 13, 2023

(54) ENHANCED CG-UL TRANSMISSION OVER PUSCH

(71) Applicant: QUALCOMM Incorporated, San Diego, CA (US)

(72) Inventors: Changlong XU, Beijing (CN); Jing SUN, San Diego, CA (US); Xiaoxia ZHANG, San Diego, CA (US)

(21) Appl. No.: 17/907,046

(22) PCT Filed: Apr. 21, 2020
(86) PCT No.: PCT/CN2020/085879

§ 371 Date: Sep. 22, 2022

(51) Int. Cl. H04L 1/1867

(52) U.S. Cl. CPC H04L 1/1893

(57) ABSTRACT

Wireless communications systems and methods related to determining the HARQ process ID for a subset of HARQ processes in a configured grant resource are provided. A first wireless communication device determines a starting hybrid automatic repeat request (HARQ) process identifier (ID) for HARQ processes for communicating in a configured grant resource including a number of slots N, each slot of the N number of slots including a number of physical uplink shared channels (PUSCHs) M, and a repetition factor K, wherein N, M, and K are integers greater than or equal to one (1), and the first wireless communication device communicates with a second wireless communication device a first communication associated with the determined starting HARQ process ID.

### TECHNICAL FIELD

This application relates to wireless communication systems, including determining the HARQ process ID for a subset of HARQ processes in a configured grant resource.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

One approach to providing a high-reliability communication is to apply HARQ techniques. For example, a UE may transmit an uplink (UL) transmission to a BS and the BS may provide the UE with a reception status of the UL transmission. If the BS receives the UL transmission successfully, the BS may transmit a HARQ-acknowledgement (HARQ-ACK) to the UE. Conversely, if the BS fails to receive the UL transmission successfully, the BS may transmit a HARQ-negative-acknowledgement (HARQ-NACK) to the UE. Upon receiving a HARQ-NACK from the BS, the UE may retransmit the UL transmission. The UE may retransmit the UL transmission until a HARQ-ACK is received from the BS or reaching a certain retransmission limit.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication includes determining, by a first wireless communication device, a starting hybrid automatic repeat request (HARQ) process identifier (ID) for HARQ processes for communicating in a configured grant resource including a number of slots N, each slot of the N number of slots including a number of physical uplink shared channels (PUSCHs) M, and a repetition factor K, wherein N, M, and K are integers greater than or equal to one (1); and communicating, by the first wireless communication device with a second wireless communication device, a first communication associated with the determined starting HARQ process ID.

In an additional aspect of the disclosure, a method of wireless communication includes communicating, by the first wireless communication device, a communication for each HARQ process in a subset of the HARQ processes in the configured grant resource, where a beginning communication in the configured grant resource corresponds to the first communication, and the subset of the HARQ processes includes a number of subset HARQ processes L each identified by one of a number of HARQ process IDs L, and the communications are in a frequency band located within a licensed spectrum.

In an additional aspect of the disclosure, a method of wireless communication includes basing L on N*M/K, wherein a number of the HARQ processes Y is an integer multiple of the number of subset HARQ processes L, wherein a periodicity of the configured grant resource is P, wherein P is an integer greater than or equal to one (1), wherein a current symbol S is a beginning symbol of a beginning slot of the N number of slots in the configured grant resource, and wherein the determining the starting HARQ process ID further includes basing the starting HARQ process ID on {[floor(S/P)]modulo[Y/L]}*L.

In an additional aspect of the disclosure, a method of wireless communication includes the configured grant resource having a first periodicity, wherein the determining the starting HARQ process ID further includes basing the starting HARQ process ID on a second periodicity that is a multiple of the first periodicity, and wherein the second periodicity is based on a number of the HARQ processes Y not being an integer multiple of L.

In an additional aspect of the disclosure, a method of wireless communication includes a number of the HARQ processes Y is not an integer multiple of the number of subset HARQ processes L, and the determining the starting HARQ process ID further includes basing the starting HARQ process ID on [floor(S/P/Y)]modulo[Y*L].

In an additional aspect of the disclosure, a method of wireless communication includes communicating, by the first wireless communication device, a last communication in the configured grant resource with less than K repetitions based on a total number of PUSCHs in the configured grant resource not being an integer multiple of K.

In an additional aspect of the disclosure, a method of wireless communication includes M*N not being an integer multiple of K, wherein the number of subset HARQ processes L is based on ceiling(M*N/K), wherein a transport block is associated with each of the number of subset HARQ processes L, wherein the transport block associated with each of the first L-1 of the number of subset HARQ processes L has K repetitions, and wherein the transport block associated with each of the remaining HARQ processes of the number of subset HARQ processes L has M*N-K*(L-1) repetitions.

In an additional aspect of the disclosure, a method of wireless communication includes communicating, by the first wireless communication device, one or more communications in the configured grant resource based on a second repetition factor, wherein the second repetition factor is based on a total number of PUSCHs in the configured grant resource not being an integer multiple of K.

In an additional aspect of the disclosure, a method of wireless communication includes M*N not being an integer multiple of K, wherein L is based on ceiling(M*N/K), wherein the transport block associated with each of the first L-M*N+floor(M*N/L)*L of the number of subset HARQ processes L has floor(M*N/L) repetitions, and wherein the transport block associated with each of the remaining M*N-floor(M*N/L)*L of the number of subset HARQ processes L has floor(M*N/L)+1 repetitions.

In an additional aspect of the disclosure, a method of wireless communication includes communicating, by the first wireless communication device, the communication for each of the number of subset HARQ processes L in the configured grant resource with K or more repetitions based on the repetition factor K.

In an additional aspect of the disclosure, a method of wireless communication includes communicating a last communication in the configured grant resource with greater than K repetitions based on a total number of PUSCHs in the configured grant resource not being an integer multiple of K.

In an additional aspect of the disclosure, a method of wireless communication includes M*N not being an integer multiple of K, wherein L is based on floor(M*N/K), wherein a transport block is associated with each of the number of subset HARQ processes L, wherein the transport block associated with each of the first L-1 of the number of subset HARQ processes L has K repetitions, and wherein the transport block associated with each of the remaining of the number of subset HARQ processes L has M*N-K*(L-1) repetitions.

In an additional aspect of the disclosure, a first wireless communication device comprises a processor configured to determine a starting hybrid automatic repeat request (HARQ) process identifier (ID) for HARQ processes for communicating in a configured grant resource including a number of slots N, each slot of the N number of slots including a number of physical uplink shared channels (PUSCHs) M, and a repetition factor K, wherein N, M, and K are integers greater than or equal to one (1), and a transceiver configured to communicate, with a second wireless communication device, a first communication associated with the determined starting HARQ process ID.

In an additional aspect of the disclosure, a non-transitory computer-readable medium having program code recorded thereon, the program code, when executed by a processor in a first wireless communication device, comprises code for causing the first wireless communication device to determine a starting hybrid automatic repeat request (HARQ) process identifier (ID) for HARQ processes for communicating in a configured grant resource including a number of slots N, each slot of the N number of slots including a number of physical uplink shared channels (PUSCHs) M, and a repetition factor K, wherein N, M, and K are integers greater than or equal to one (1), and communicate, with a second wireless communication device, a first communication associated with the determined starting HARQ process ID.

In an additional aspect of the disclosure, a first wireless communication device comprises means for determining a starting hybrid automatic repeat request (HARQ) process identifier (ID) for HARQ processes for communicating in a configured grant resource including a number of slots N, each slot of the N number of slots including a number of physical uplink shared channels (PUSCHs) M, and a repetition factor K, wherein N, M, and K are integers greater than or equal to one (1), and means for communicating, with a second wireless communication device, a first communication associated with the determined starting HARQ process ID.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2A illustrates a hybrid automatic repeat request (HARQ) communication scenario according to some aspects of the present disclosure.

FIG. 2B illustrates a hybrid automatic repeat request (HARQ) communication scenario according to some aspects of the present disclosure.

FIG. 3 is a block diagram of a user equipment (UE) according to some aspects of the present disclosure.

FIG. 4 is a block diagram of an exemplary base station (BS) according to some aspects of the present disclosure.

FIG. 5 illustrates a HARQ transmission scheme using configured resources according to some aspects of the present disclosure.

FIG. 6 illustrates a HARQ transmission scheme using configured resources according to some aspects of the present disclosure.

FIG. 7 illustrates a HARQ transmission scheme using configured resources according to some aspects of the present disclosure.

FIG. 8 illustrates a HARQ transmission scheme using configured resources according to some aspects of the present disclosure.

FIG. 9 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive internet of things (IoTs) with a ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

In a wireless communication network, a base station (BS) may configure a user equipment (UE) with a configured grant for autonomous transmission or non-scheduled transmission. Each configured grant is associated with a set of resources configured for the UE to transmit UL communications (e.g., data and/or control information) without being scheduled by the BS. The set of configured resource may occur periodically. The set of configured resources may correspond to transmission time occasions. In some instances, the UE may use the configured resources for transmitting a transport block (TB) on a physical uplink shared channel (PUSCH). To improve communication reliability, the UE may apply hybrid automatic repeat request (HARQ) techniques to the UL data transmission. Additionally, the UE may perform the UL data transmission with repetitions using different redundancy versions to improve decoding performance at the BS. When operating over a licensed band, the BS may assign a HARQ process and/or a HARQ redundancy version for transmission in each transmission time occasion. In other words, the BS may provide a mapping or association between HARQ process/redundancy version to configured resource in the time domain. The UE may transmit UL HARQ data in the configured transmission occasions based on the association.

The BS may provide a UE with information indicating the number of HARQ processes for a configured grant. The BS may also provide a UE with parameters indicating the number of slots within the configured grant resource, the number of PUSCHs per slot, and the repetition factor for each TB. To provide mapping between HARQ process/redundancy version to configured resource in the time domain, each PUSCH transmission by the UE may be associated with a HARQ process that is associated with a HARQ process identifier (ID). The BS may provide the UE a number of PUSCHs within a period of the configured grant resource that is unable to accommodate each of the number of HARQ processes for a configured grant indicated by the BS. As a result, a UE may communicate TBs that are associated with a subset of the HARQ processes for the configured grant resources. Each HARQ process may be associated with a HARQ process ID, and the UE may thus communicate TBs associated with a subset of the possible HARQ process IDs. The BS and UE therefore may determine which of the subset of HARQ process IDs are associated with each communication in the configured grant resource. The UE and BS may also determine the HARQ process ID of the beginning communication (e.g., the starting HARQ process ID) in the configured grant resource.

The present application describes mechanisms for determining a starting hybrid automatic repeat request (HARQ) process identifier (ID) for HARQ processes in a configured grant resource. For instance, a BS may provide a UE with a configured grant resource including a number of slots N, each slot of the N number of slots including a number of physical uplink shared channels (PUSCHs) M, and a repetition factor K. A first wireless communication device may communicate a communication for each HARQ process in a subset of the HARQ processes in the configured grant resource, wherein the subset of the HARQ processes includes a number of subset HARQ processes L each identified by one of a number of HARQ process IDs L. The first wireless communication device may further determine a starting HARQ process ID associated with the first PUSCH or communication in the configured grant resource.

In some aspects, the starting HARQ process ID is based on Y and L. In some aspects, the number of subset HARQ processes L is based on N*M/K, ceiling(M*N/K), or floor(M*N/K). In some aspects, a number of the HARQ processes in the configured grant Y is an integer multiple of the number of subset HARQ processes L. In some aspects, determining the starting HARQ process ID further includes basing the starting HARQ process ID on a second periodicity that is a multiple of the first periodicity, and wherein the second periodicity is based on a number of the HARQ processes Y not being an integer multiple of L.

In some aspects, the first wireless communication device may communicate a last communication in the configured grant resource with less than K repetitions based on a total number of PUSCHs in the configured grant resource not being an integer multiple of K. In some aspects, a first wireless communication device may communicate one or more communications in the configured grant resource based on a second repetition factor, wherein the second repetition factor is based on a total number of PUSCHs in the configured grant resource not being an integer multiple of K.

Aspects of the present disclosure can provide several benefits. For instance, the present disclosure includes mechanisms for improving HARQ communication reliability. For example, the present disclosure provides for higher data rates, more data capacity, and improved spectral efficiency by improving HARQ communication reliability. Additionally, the present disclosure includes the benefit of allowing the UE and BS to determine the starting HARQ process ID where the BS configures multiple configured grant PUSCH resources within a slot and multiple slots within a configured grant resource period, which beneficially allows the UE to enhance UL HARQ transmission. Furthermore, the present disclosure includes the benefit of allowing the UE and BS to determine the starting HARQ process ID where the BS configures TBs to be transmitted with a repetition factor, which beneficially allows the UE to repeatedly transmit a TB, providing time diversity that protects the transmissions from fading effects.

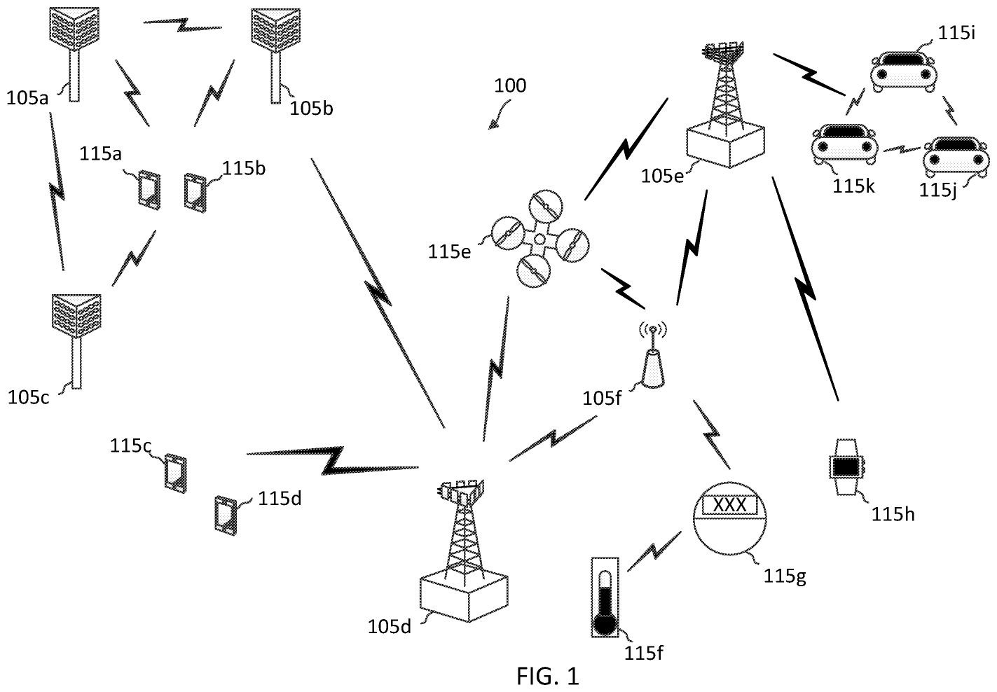

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used. 3

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may provide to a UE 115 (or 300) a configured grant resource. Via network 100, BS 105 (or 400) may communicate with UE 115 to indicate a number of HARQ processes for a configured grant resource. BS 105 may also communicate to the UE parameters regarding the configured grant resource, such as the number of PUSCHs per slot and the number of slots in a configured grant resource period. The UE 115 may communicate with BS 105 TBs associated with HARQ processes via network 100. Network 100, BS 105, and/or UE 115 may determine a starting HARQ process ID and HARQ process IDs for each of HARQ processes associated with configured grant PUSCHs, where the BS and UE may communicate using a subset of the available HARQ processes.

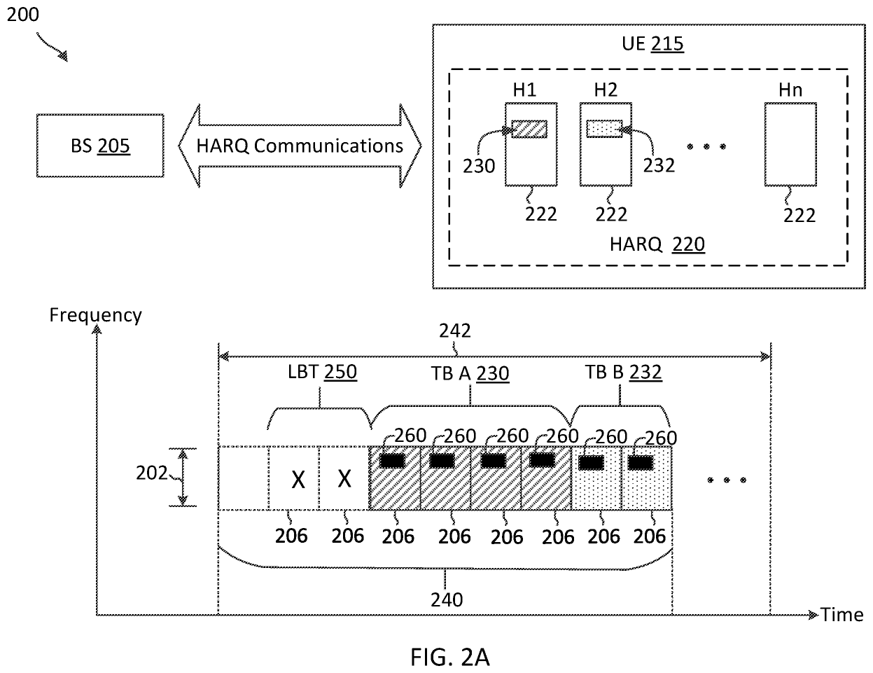

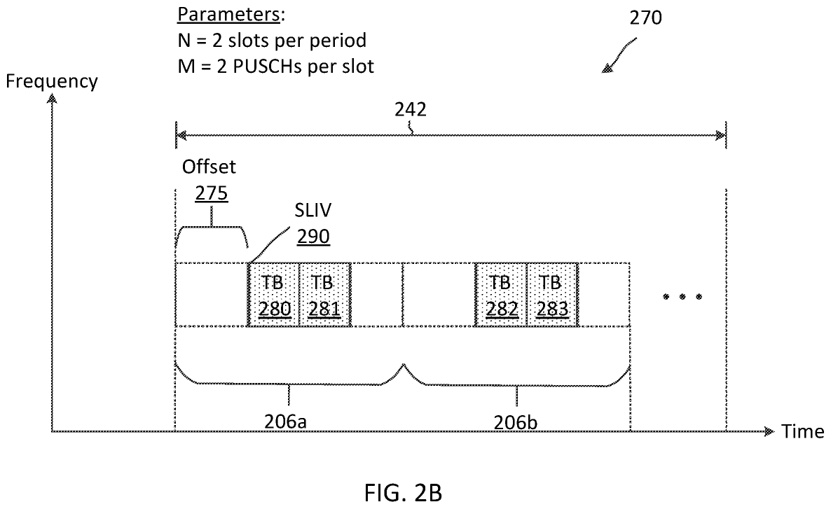

FIG. 2A illustrates a hybrid automatic repeat request (HARQ) communication scenario according to some aspects of the present disclosure. The scenario 200 may correspond to a HARQ communication scenario in the network 100 when the network 100 operates over a shared frequency band or an unlicensed frequency band. In FIG. 2A, the x-axis represents time in some constant units. In the scenario 200, a BS 205 similar to the BSs 105 may communicate data with a UE 215 similar to the UEs 115 using HARQ over a frequency band 202, which may be a licensed frequency band or a shared radio frequency band in a shared spectrum or an unlicensed spectrum, shared by multiple network operating entities. The frequency band 202 may be located at any suitable frequencies. In some aspects, the frequency band 202 may be located at about 3.5 GHz, 6 GHz, or 30 GHz.

For HARQ communications, a transmitting node (e.g., the UE 215) may transmit data (e.g., in the form of a TB) to a receiving node (e.g., the BS 205). The receiving node may provide the transmitting node with a feedback on the reception status of the data. For example, the receiving node may transmit an ACK to the transmitting node to indicate a successful decoding of the data. Conversely, the receiving node may transmit a NACK to the transmitting node to indicate a decoding failure for the data. When the transmitting node receives an ACK from the receiving node, the transmitting node may transmit new data in a subsequent transmission. However, when the transmitting node receives a NACK from the receiving node, the transmitting node may retransmit the same data to the receiving node. In some instances, the transmitting node may use the same encoding version for the initial transmission and the retransmission. In some other instances, the transmitting node may use different encoding versions for the initial transmission and the retransmission. The encoding versions may be referred to as redundancy versions. Different redundancy versions may include different combinations of systematic data information bits and error correction bit. In some aspects, the receiving node may perform soft-combining to decode the data based on the initial transmission and the retransmission. For simplicity of discussion and illustration, FIG. 2A illustrates the HARQ communication in the context of UL data communications, though similar HARQ mechanisms may be applied to DL data communications.

As an example, the UE 215 includes a HARQ component 220. The HARQ component 220 is configured to perform multiple parallel HARQ processes 222 for UL data communications. The HARQ processes 222 may operate independent of each other. In other words, the ACKs, NACKs, and/or retransmissions are determined and processed separately for each HARQ process 222 at the BS 205 and at the UE 215. Each HARQ process 222 may be identified by a HARQ process identifier (ID). For example, the HARQ processes 222 may be identified by identifiers H1, H2, . . . Hn. Each HARQ process 222 may have one or more TBs ready for transmission. In the illustrated example of FIG. 2A, the HARQ process H1 222 has one TB 230 ready for transmission and the HARQ process H2 222 has one TB 232 ready for transmission. The BS 205 may configure the UE 215 with configured resources for autonomous or unscheduled transmission. The UE 215 may transmit the TB 230 and the TB 232 to the BS 205 using a configured resource.

In some aspects, the BS 205 may configure the UE 215 with a configured resource 240. The configured resource 240 may be periodic. For instance, the configured resource 240 may repeated at a time interval 242. The configured resource 240 may be partitioned into a plurality transmission time periods or slots 206. Each slot 206 may include any suitable number of OFDM symbols depending on the transmission configurations or numerology (e.g., the subcarrier spacing (SCS) and/or the cyclic prefix (CP) mode) in use.

The UE 215 may perform an LBT 250 in the frequency band 202 prior to a transmission. As an example, a first LBT 250 attempt for a transmission in a second slot 206 within the configured resource 240 failed (shown by the cross symbol). A second LBT 250 attempt for a transmission in a third slot 206 within the configured resource 240 also failed (shown by the cross symbol). A third LBT attempt for a transmission in a fourth slot 206 within the configured resource 240 is a pass. Thus, the UE 215 may initiate a transmission beginning at the fourth slot 206. Once the UE 215 won a contention (e.g., passing the LBT 250), the UE 215 may use the configured resource for a number of consecutive HARQ transmissions.

In the illustrated example of FIG. 2A, after passing the LBT 250, the UE 215 transmits four repetitions of the TB 230, denoted as TB A, followed by two repetitions of the TB 232, denoted as TB B, in consecutive slots 206. In some aspects, the UE 215 may transmit the repetitions for the TB 230 using different redundancy versions and/or the same redundancy versions. In some instances, each repetition may use a different RVN. In some instances, all repetitions may use the same RVN. In some instances, at least two repetitions may use the same RVN. Similarly, the UE 215 may transmit the repetitions for the TB 232 using different redundancy versions and/or the same redundancy versions. In some aspects, the UE 215 may include a RVN and/or a HARQ ID for each transmission, for example, in uplink control information (UCI) 260. For instance, the RVN may indicate a RV0, a RV1, a RV2, a RV3, a RV4, and so on. Each transmission for the TB A 230 may include UCI 260 indicating a HARQ ID H1 Similarly, each transmission for the TB B 232 may include UCI 260 indicating a HARQ ID H2. The UE 215 may further indicate whether a transmission is an initial transmission or a retransmission by including a new data indicator (NDI) in the UCI 260. For example, the NDI may be set to a value of 1 to indicate that a corresponding transmission is an initial transmission and may be set to a value of 0 to indicate that a corresponding transmission is a retransmission. For instance, the UCI 260 for each transmission of the TB A 230 may include a NDI with a value of 1 to indicate that the repetitions of the TB A 230 are associated with an in initial transmissions of the TB A 230. The UCI 260 for each transmission of the TB B 232 may include a NDI with a value of 0 to indicate that the repetitions of the TB B 232 are associated with a retransmission of the TB B 232. In some aspects, the UE 215 may determine a RV sequence (e.g., a sequence of RVNs) for transmitting one or more redundancy versions of a TB in a configured resource and/or how to prioritize transmission of one TB of a certain HARQ process 222 over another TB of another HARQ process 222 without assistance from the BS 205. In some other instances, the BS 205 may provide the UE with some assistance in the RV sequence determination and/or HARQ ID selection.

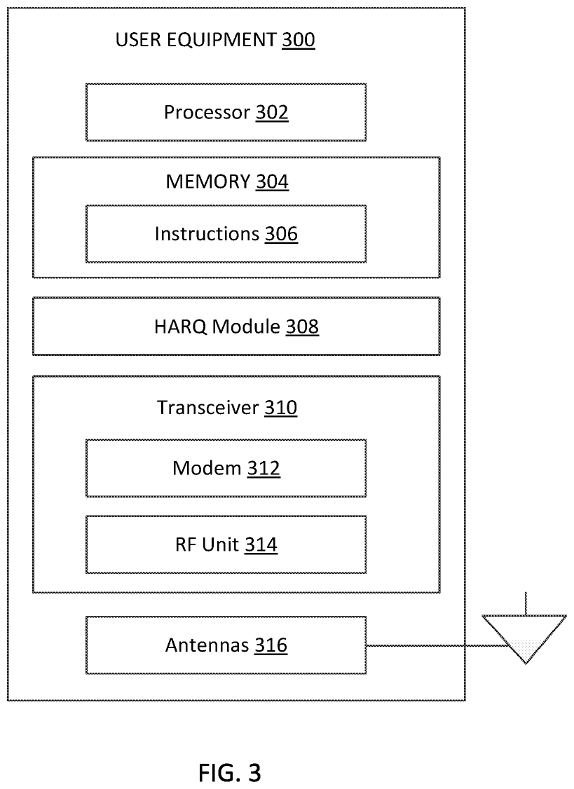

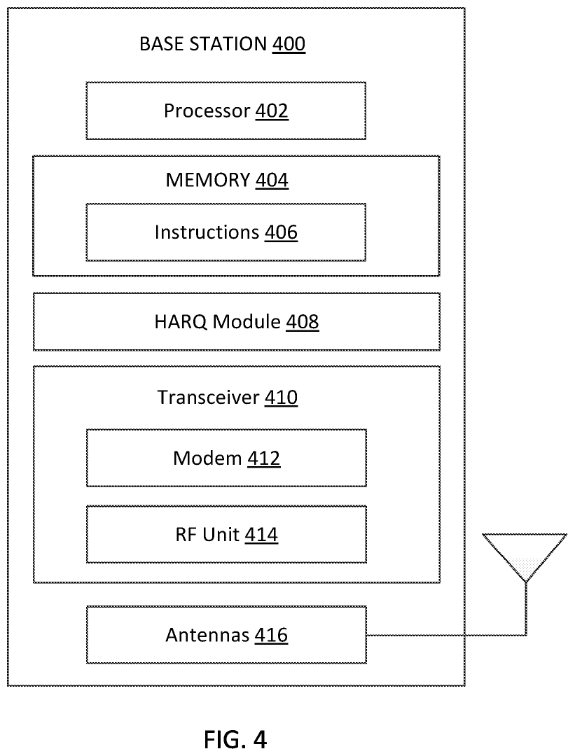

FIG. 2B illustrates a hybrid automatic repeat request (HARQ) communication scenario according to some aspects of the present disclosure. The functionality of scheme 270 can be executed by a computing device (e.g., a processor, processing circuit, and/or other suitable component) of a wireless communication device or other suitable means. In some aspects, a wireless communication device such as the UE 115 or UE 300 of FIG. 3 may utilize one or more components, such as the processor 302, the memory 304, the HARQ module 308, the transceiver 310, the modem 312, and the one or more antennas 316, to execute the steps of scheme 270. Further, a wireless communication device such as the base station (BS) 105 or BS 400 of FIG. 4 may utilize one or more components, such as the processor 402, the memory 404, the HARQ module 408, the transceiver 410, the modem 412, and the one or more antennas 416, to execute the steps of scheme 270. The scheme 270 may employ similar mechanisms as described in FIGS. 1-2A and 3-9. In FIG. 2B, the x-axis represents time in some arbitrary units, and the y-axis represents frequency in some arbitrary units.

As illustrated in FIG. 2B, TBs 280, 281, 282, and 283 may be transmitted in more than one slot 206a and 206b of a configured grant resource 242. For instance, TBs may be transmitted in a number N slots per period. More than one TB may be transmitted in each of the multiple slots of the configured grant resource. For instance, TBs may be transmitted in a number M PUSCHs per slot. The BS may configure a number of HARQ processes Y (or NumHARQproc) associated with the PUSCHs of the configured grant resource 242. The configured grant resource 242 can be may be a licensed or unlicensed frequency band or spectrum.

A BS may provide a UE with an information element or parameter(s) including a start and length indicator value (SLIV) 290 for a first PUSCH in a slot, where a SLIV indicates the starting position in terms of the current symbol or a symbol index and the length of the PUSCH. The PUSCH starting position and length may repeat over each of the plurality of slots associated with the configured grant resources. For instance, SLIV 290 indicates the position of the first PUSCH of the first slot 206a of the configured grant resource 242. The position of the first PUSCH of the first slot may be offset 275 from the beginning of the configured grant resource 242.

In some aspects, communicating the TBs 280, 281, 282, and 283 comprises receiving, by a first wireless communication device (e.g., BS 105/400), a TB on a PUSCH associated with the starting HARQ process ID. In some instances, communicating a TB comprises transmitting, by a first wireless communication device (e.g., UE 115/300), a TB on a PUSCH associated with a starting HARQ process ID.

FIG. 3 is a block diagram of an exemplary UE 300 according to some aspects of the present disclosure. The UE 300 may be a UE 115 discussed above in FIG. 1. As shown, the UE 300 may include a processor 302, a memory 304, a HARQ module 308, a transceiver 310 including a modem subsystem 312 and a radio frequency (RF) unit 314, and one or more antennas 316. These elements may be in direct or indirect communication with each other, for example via one or more buses.

The processor 302 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 302 may also be implemented as a combination of computing devices, e.g., a combination of a DSP and a microprocessor, a plurality of microprocessors, one or more microprocessors in conjunction with a DSP core, or any other such configuration.

The memory 304 may include a cache memory (e.g., a cache memory of the processor 302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 304 includes a non-transitory computer-readable medium. The memory 304 may store, or have recorded thereon, instructions 306. The instructions 306 may include instructions that, when executed by the processor 302, cause the processor 302 to perform the operations described herein with reference to the UEs 115 in connection with aspects of the present disclosure, for example, aspects of FIGS. 1-2B and 5-9. Instructions 306 may also be referred to as program code. The program code may be for causing a wireless communication device to perform these operations, for example by causing one or more processors (such as processor 302) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The HARQ module 308 may be implemented via hardware, software, or combinations thereof. For example, HARQ module 308 may be implemented as a processor, circuit, and/or instructions 306 stored in the memory 304 and executed by the processor 302. In some examples, the HARQ module 308 can be integrated within the modem subsystem 312. For example, the HARQ module 308 can be implemented by a combination of software components (e.g., executed by a DSP or a general processor) and hardware components (e.g., logic gates and circuitry) within the modem subsystem 312. In some examples, a UE may include one or more HARQ module 308.

The HARQ module 308 may be used for various aspects of the present disclosure, for example, aspects of FIGS. 1-2B and 5-9. In some aspects, the HARQ module 308 can be configured to determine HARQ process IDs associated with a subset of HARQ processes in a configured grant resource. In some aspects, the HARQ module 308 can be configured to determine HARQ process IDs based on one or more repetition factors or other parameters. In some aspects, the HARQ module 308 can be configured to determine one or more periodicities or repetition factors associated with TBs associated with the subset of HARQ processes. In some aspects, the HARQ module 308 can be configured to communicate with another wireless communication device TBs associated with the determined HARQ process IDs. In some aspects, the HARQ module 308 can be configured to communicate a TB in a PUSCH associated with a determined starting HARQ process ID.

As shown, the transceiver 310 may include the modem subsystem 312 and the RF unit 314. The transceiver 310 can be configured to communicate bi-directionally with other devices, such as the BSs 105. The modem subsystem 312 may be configured to modulate and/or encode the data from the memory 304 and/or the configured transmission module 307 according to a modulation and coding scheme (MCS), e.g., a low-density parity check (LDPC) coding scheme, a turbo coding scheme, a convolutional coding scheme, a digital beamforming scheme, etc. The RF unit 314 may be configured to process (e.g., perform analog to digital conversion or digital to analog conversion, etc.) modulated/encoded data (e.g., configured grant UL transmissions, PUSCH) from the modem subsystem 312 (on outbound transmissions) or of transmissions originating from another source such as a UE 115 or a BS 105. The RF unit 314 may be further configured to perform analog beamforming in conjunction with the digital beamforming. Although shown as integrated together in transceiver 310, the modem subsystem 312 and the RF unit 314 may be separate devices that are coupled together at the UE 115 to enable the UE 115 to communicate with other devices.

The RF unit 314 may provide the modulated and/or processed data, e.g. data packets (or, more generally, data messages that may contain one or more data packets and other information), to the antennas 316 for transmission to one or more other devices. The antennas 316 may further receive data messages transmitted from other devices. The antennas 316 may provide the received data messages for processing and/or demodulation at the transceiver 310. The transceiver 310 may provide the demodulated and decoded data (e.g., configured grant information, parameters, bitmaps, other system and channel parameters, HARQ-ACK messages) to the configured transmission module 307 for processing. The antennas 316 may include multiple antennas of similar or different designs in order to sustain multiple transmission links. The RF unit 314 may configure the antennas 316. In an example, the transceiver 310 is configured to receive, from a base station (BS), information or parameters regarding a configured grant resource, and communicate, with the BS, PUSCHs and HARQ-ACKs associated with HARQ processes and HARQ process IDs, for example, by coordinating with the HARQ module 308.

In an aspect, the UE 300 can include multiple transceivers 510 implementing different RATs (e.g., NR and LTE). In an aspect, the UE 300 can include a single transceiver 310 implementing multiple RATs (e.g., NR and LTE). In an aspect, the transceiver 310 can include various components, where different combinations of components can implement different RATs.

FIG. 4 is a block diagram of an exemplary BS 400 according to some aspects of the present disclosure. The BS 400 may be a BS 105 in the network 100 as discussed above in FIG. 1. A shown, the BS 400 may include a processor 402, a memory 404, HARQ module 408, a transceiver 410 including a modem subsystem 412 and a RF unit 414, and one or more antennas 416. These elements may be in direct or indirect communication with each other, for example via one or more buses.

The processor 402 may have various features as a specific-type processor. For example, these may include a CPU, a DSP, an ASIC, a controller, a FPGA device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 404 may include a non-transitory computer-readable medium. The memory 404 may store instructions 406. The instructions 406 may include instructions that, when executed by the processor 402, cause the processor 402 to perform operations described herein, for example, aspects of FIGS. 1-2B and 5-9. Instructions 406 may also be referred to as code, which may be interpreted broadly to include any type of computer-readable statement(s) as discussed above with respect to FIG. 3.

The HARQ module 408 may be implemented via hardware, software, or combinations thereof. For example, the HARQ module 408 may be implemented as a processor, circuit, and/or instructions 406 stored in the memory 404 and executed by the processor 402. In some examples, the HARQ module 408 can be integrated within the modem subsystem 412. For example, the HARQ module 408 can be implemented by a combination of software components (e.g., executed by a DSP or a general processor) and hardware components (e.g., logic gates and circuitry) within the modem subsystem 412. In some examples, a UE may include one or more HARQ module 408.

The HARQ module 408 may be used for various aspects of the present disclosure, for example, aspects of FIGS. 1-2B and 5-9. In some aspects, the HARQ module 408 can be configured to determine HARQ process IDs associated with a subset of HARQ processes in a configured grant resource. In some aspects, the HARQ module 408 can be configured to determine HARQ process IDs based on one or more repetition factors or other parameters. In some aspects, the HARQ module 408 can be configured to determine one or more periodicities or repetition factors associated with TBs associated with the subset of HARQ processes. In some aspects, the HARQ module 408 can be configured to communicate with another wireless communication device TBs associated with the determined HARQ process IDs. In some aspects, the HARQ module 408 can be configured to communicate a TB PUSCH associated with a determined starting HARQ process ID.

As shown, the transceiver 410 may include the modem subsystem 412 and the RF unit 414. The transceiver 410 can be configured to communicate bi-directionally with other devices, such as the UEs 115 and/or 300 and/or another core network element. The modem subsystem 412 may be configured to modulate and/or encode data according to a MCS, e.g., a LDPC coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data (e.g., configured grant information, parameters, bitmaps, other system and channel parameters, HARQ-ACK messages) from the modem subsystem 412 (on outbound transmissions) or of transmissions originating from another source such as a UE 115 and/or UE 300. The RF unit 414 may be further configured to perform analog beamforming in conjunction with the digital beamforming. Although shown as integrated together in transceiver 410, the modem subsystem 412 and/or the RF unit 414 may be separate devices that are coupled together at the BS 105 to enable the BS 105 to communicate with other devices.

The RF unit 414 may provide the modulated and/or processed data, e.g. data packets (or, more generally, data messages that may contain one or more data packets and other information), to the antennas 416 for transmission to one or more other devices. This may include, for example, transmission of information to complete attachment to a network and communication with a camped UE 115 or 400 according to some aspects of the present disclosure. The antennas 416 may further receive data messages transmitted from other devices and provide the received data messages for processing and/or demodulation at the transceiver 410. The transceiver 410 may provide the demodulated and decoded data (e.g., configured grant UL transmissions, PUSCH) to the communication module 408 and configured transmission module 408 for processing. The antennas 416 may include multiple antennas of similar or different designs in order to sustain multiple transmission links. In an example, the transceiver 410 is configured to transmit, to a UE, information or parameters regarding a configured grant resource, and communicate, with the UE, PUSCHs and HARQ-ACKs associated with HARQ processes and HARQ process IDs, for example, by coordinating with the HARQ module 408.

In an aspect, the BS 400 can include multiple transceivers 410 implementing different RATs (e.g., NR and LTE). In an aspect, the BS 400 can include a single transceiver 410 implementing multiple RATs (e.g., NR and LTE). In an aspect, the transceiver 410 can include various components, where different combinations of components can implement different RATs.

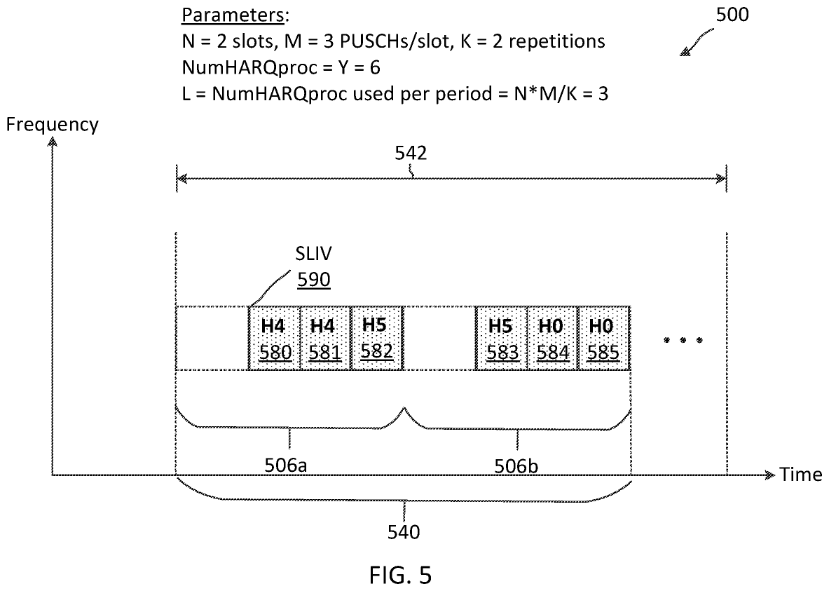

FIG. 5 illustrates a HARQ transmission scheme using configured resources according to some aspects of the present disclosure. The functionality of scheme 500 can be executed by a computing device (e.g., a processor, processing circuit, and/or other suitable component) of a wireless communication device or other suitable means. In some aspects, a wireless communication device such as the UE 115 or UE 300 of FIG. 3 may utilize one or more components, such as the processor 302, the memory 304, the HARQ module 308, the transceiver 310, the modem 312, and the one or more antennas 316, to execute the steps of scheme 500. Further, a wireless communication device such as the base station (BS) 105 or BS 400 of FIG. 4 may utilize one or more components, such as the processor 402, the memory 404, the HARQ module 408, the transceiver 410, the modem 412, and the one or more antennas 416, to execute the steps of scheme 500. The scheme 500 may employ similar mechanisms as described in FIGS. 1-4 and 6-9. In FIG. 5, the x-axis represents time in some arbitrary units, and the y-axis represents frequency in some arbitrary units.

As illustrated in FIG. 5, the number of HARQ processes of a period may be greater than the number of HARQ processes that a UE may use in a configured grant resource 542. For instance, a configured grant resource may include a number Y of HARQ processes. However, based on a SLIV 590, a number N slots per, a number M PUSCHs per slot, and a repetition factor K, not all of the HARQ processes may be accommodated within the configured grant period, and the UE may transmit TBs associated with a subset of the HARQ processes.

In some aspects, a UE may transmit TBs 580, 581, 582, 583, 584, and 585 associated with a subset L number of HARQ processes, where L=N*M/K and Y is an integer multiple of L. For example, as illustrated in FIG. 5, the HARQ parameters may include N=2, M=3, K=2, Y=6, and L=3. The configured grant period may only be able to accommodate TBs in PUSCHs associated with half of the Y HARQ processes (e.g., TBs associated with HARQ process IDs H4, H5, and H0) but not in the other half of the Y HARQ processes (e.g., H1, H2, H3). The UE and BS may determine starting HARQ process ID by basing the starting HARQ process ID on {[floor(S/P)]modulo[Y/L]}*L, where a periodicity of the configured grant resource is P and a current symbol S is a beginning symbol of a beginning slot of the N number of slots in the configured grant resource. The current symbol may be determined based on CURRENT_symbol=(SFN*numberOfSlotsPerFrame*numberOfSymbolsPerSlot+slot number in the frame*numberOfSymbolsPerSlot+symbol number in the slot), where numberOfSlotsPerFrame refer to the number of consecutive slots per frame and numberOfSymbolsPerSlot refer to the number of consecutive symbols per slot. In some aspects, J is an integer with the values J=0, 1, . . . , L-1, and each of the number of HARQ process IDs L is based on [(starting HARQ process ID)+J]modulo[Y]. The first K TBs transmitted during the CG period are associated with the first HARQ process ID. For instance, TB 580 and 581 are associated with H4. The next K TBs transmitted during the CG period are associated with the next process ID, etc., for the L number of HARQ process IDs.

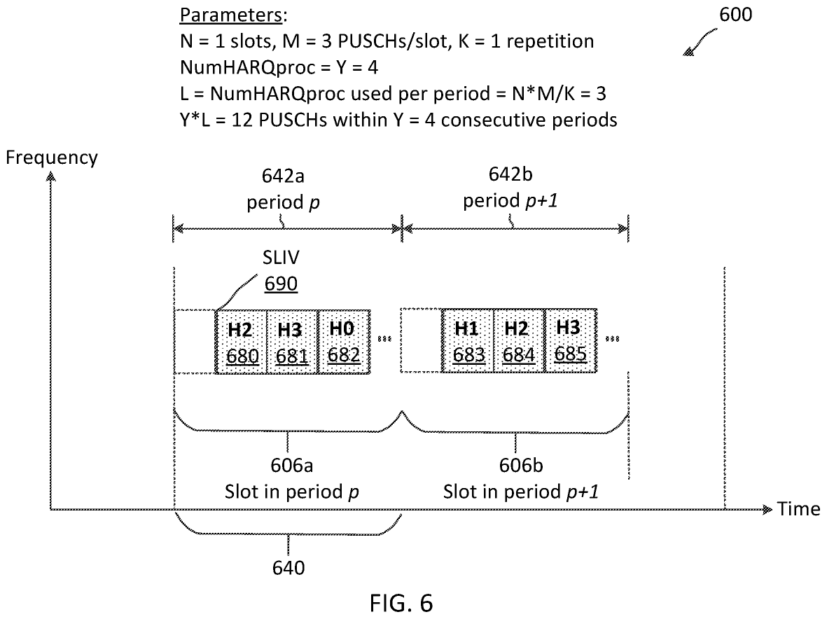

FIG. 6 illustrates a HARQ transmission scheme using configured resources according to some aspects of the present disclosure. The functionality of scheme 600 can be executed by a computing device (e.g., a processor, processing circuit, and/or other suitable component) of a wireless communication device or other suitable means. In some aspects, a wireless communication device such as the UE 115 or UE 300 of FIG. 3 may utilize one or more components, such as the processor 302, the memory 304, the HARQ module 308, the transceiver 310, the modem 312, and the one or more antennas 316, to execute the steps of scheme 600. Further, a wireless communication device such as the base station (BS) 105 or BS 400 of FIG. 4 may utilize one or more components, such as the processor 402, the memory 404, the HARQ module 408, the transceiver 410, the modem 412, and the one or more antennas 416, to execute the steps of scheme 600. The scheme 600 may employ similar mechanisms as described in FIGS. 1-5 and 7-10. In FIG. 6, the x-axis represents time in some arbitrary units, and the y-axis represents frequency in some arbitrary units.

As illustrated in FIG. 6, the number of HARQ processes Y may not be a multiple of L. In some aspects, Y periods may be defined as a super period that includes Y*L configured grant TBs. For instance, the Y HARQ process IDs associated with the Y HARQ processes will each be used L times over the Y periods. In some aspects, every Y periods will include Y*L PUSCHs associated with Y sequential HARQ processes. For example, as illustrated in FIG. 6, the HARQ parameters may include N=1, M=3, K=1, Y=4, and L=3. In a first period, where the first symbol of the beginning PUSCH is indicated by SLIV 690, the starting HARQ ID is H2, which is associated with TB 680. Then the Y HARQ process IDs associated with the Y HARQ processes (H2, H3, H0, and H1) are transmitted in Y*L PUSCHs in Y periods.

For instance, TBs associated with the Y HARQ processes may be transmitted in period p (including slot 606a), period p+1 (including slot 606b), period p+2 (not shown), and period p+3 (not shown). In some aspects, for every Y periods, the starting HARQ process ID can be determined based on [floor(S/P/Y)]modulo[Y*L], where L is based on N*M/K. In some aspects, J is an integer with the values J=0, 1, . . . , L*Y-1, and each of the number of HARQ process IDs L is based on [(starting HARQ process ID)+J]modulo[Y].

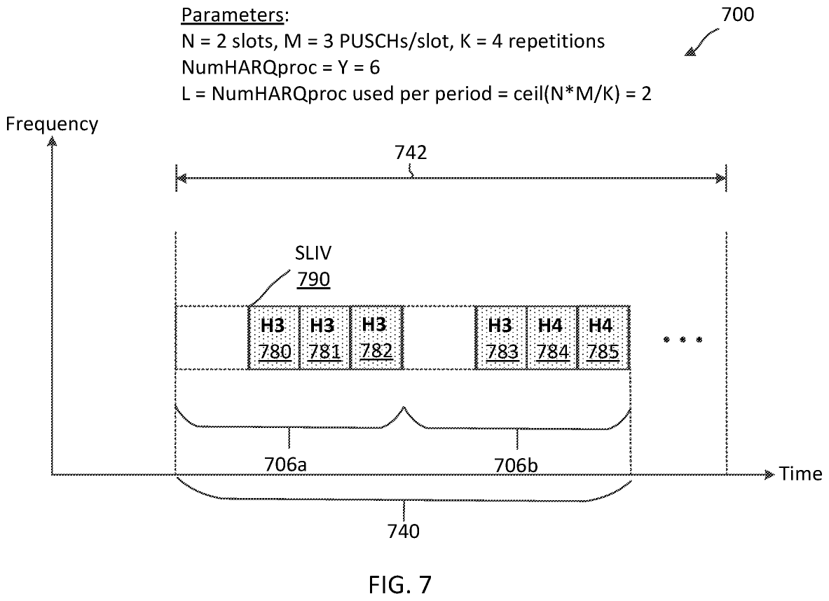

FIG. 7 illustrates a HARQ transmission scheme using configured resources according to some aspects of the present disclosure. The functionality of scheme 700 can be executed by a computing device (e.g., a processor, processing circuit, and/or other suitable component) of a wireless communication device or other suitable means. In some aspects, a wireless communication device such as the UE 115 or UE 300 of FIG. 3 may utilize one or more components, such as the processor 302, the memory 304, the HARQ module 308, the transceiver 310, the modem 312, and the one or more antennas 316, to execute the steps of scheme 700. Further, a wireless communication device such as the base station (BS) 105 or BS 400 of FIG. 4 may utilize one or more components, such as the processor 402, the memory 404, the HARQ module 408, the transceiver 410, the modem 412, and the one or more antennas 416, to execute the steps of scheme 700. The scheme 700 may employ similar mechanisms as described in FIGS. 1-6 and 8-9. In FIG. 7, the x-axis represents time in some arbitrary units, and the y-axis represents frequency in some arbitrary units.

As illustrated in FIG. 7, M*K may not be a multiple of K such that L is not an integer. For example, the HARQ parameters may include N=2, M=3, K=4, Y=6, and L=2. In such a scenario, the TBs associated with the L HARQ processes may be associated with different repetition factors where the last TB will have fewer repetitions. For instance, L may be based on ceiling(M*N/K). A first repetition factor for the first HARQ process associated with HARQ process ID H3 (TBs 780, 781, 782, 783) may be based on K=4, and a second repetition factor less than K (e.g., a repetition of 2) may be associated with HARQ process ID H4 (TBs 784, 785). In some aspects, the transport block associated with each of the first L-1 of the number of subset HARQ processes L has K repetitions, and each of the remaining HARQ processes has M*N-K*(L-1) repetitions.

In a scenario where M*K may not be a multiple of K, Y may be a multiple of L, and the HARQ process IDs may be associated with TBs of a configured grant resource as discussed above with respect to FIG. 5. Alternatively, in a scenario where M*K may not be a multiple of K, Y may not be a multiple of L, and the HARQ process IDs may be associated with TBs of a configured grant resource as discussed above with respect to FIG. 6.

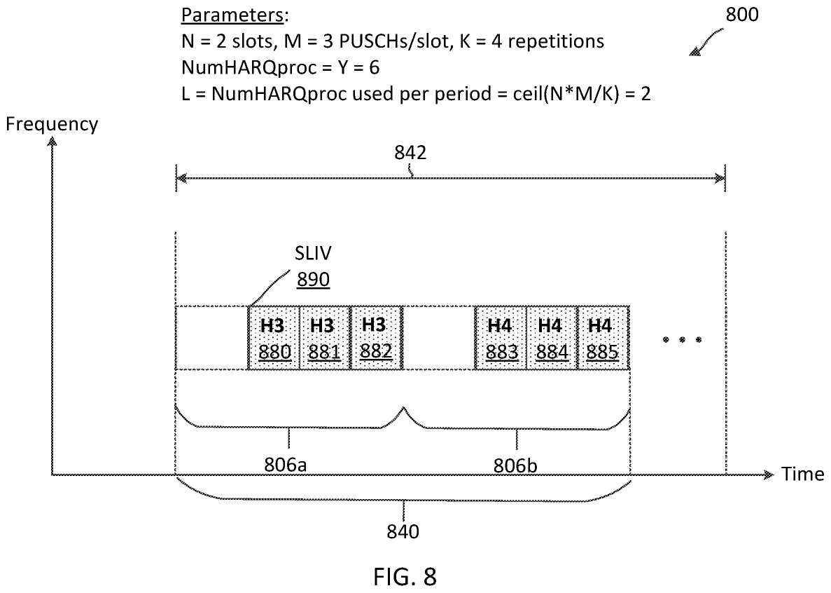

FIG. 8 illustrates a HARQ transmission scheme using configured resources according to some aspects of the present disclosure. The functionality of scheme 800 can be executed by a computing device (e.g., a processor, processing circuit, and/or other suitable component) of a wireless communication device or other suitable means. In some aspects, a wireless communication device such as the UE 115 or UE 300 of FIG. 3 may utilize one or more components, such as the processor 302, the memory 304, the HARQ module 308, the transceiver 310, the modem 312, and the one or more antennas 316, to execute the steps of scheme 800. Further, a wireless communication device such as the base station (BS) 105 or BS 400 of FIG. 4 may utilize one or more components, such as the processor 402, the memory 404, the HARQ module 408, the transceiver 410, the modem 412, and the one or more antennas 416, to execute the steps of scheme 800. The scheme 800 may employ similar mechanisms as described in FIGS. 1-7 and 9. In FIG. 8, the x-axis represents time in some arbitrary units, and the y-axis represents frequency in some arbitrary units.

As illustrated in FIG. 8, M*K may not be a multiple of K such that L is not an integer. For example, as illustrated in FIG. 8, the HARQ parameters may include N=2, M=3, K=4, Y=6, and L=2. In such a scenario, the TBs associated with the L HARQ processes may be associated with different repetition factors such that the repetitions are divided approximately uniformly over all TBs. For instance, L may be based on ceiling(M*N/K). The repetition factor for the first HARQ process associated with HARQ process ID H3 (TBs 880, 881, 882) may be based on K=3, and the repetition factor for the second HARQ process associated with HARQ process ID H4 (TBs 883, 884, 885) may be uniform (e.g., also based on K=3) or approximately uniform. In some aspects, the transport block associated with each of the first L-M*N+floor(M*N/L)*L of the number of subset HARQ processes L has floor(M*N/L) repetitions, and the transport block associated with each of the remaining M*N-floor(M*N/L)*L of the number of subset HARQ processes L has floor(M*N/L)+1 repetitions.

In further aspects, in a scenario where M*K may not be a multiple of K such that L is not an integer, the TBs associated with the L HARQ processes may be associated with different repetition factors such that the last TB has more repetitions. For instance, L may be based on floor(M*N/K), the first L-1 TBs have K repetitions, and the last TB has M*N-K(L-1) repetitions. In some aspects, each of the TBs transmitted in the configured resource grant may be repeated at least K times.

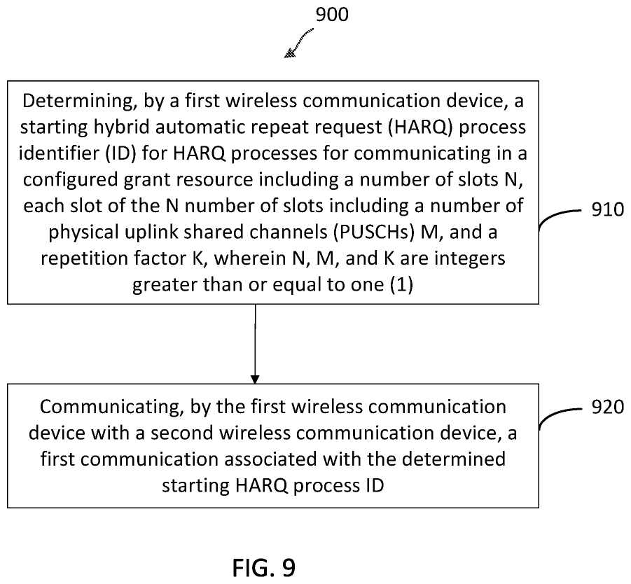

FIG. 9 is a flow diagram of a communication method according to some aspects of the present disclosure. The functionality of method 900 can be executed by a computing device (e.g., a processor, processing circuit, and/or other suitable component) of a wireless communication device or other suitable means. In some aspects, a wireless communication device such as the UE 115 or UE 300 of FIG. 3 may utilize one or more components, such as the processor 302, the memory 304, the HARQ module 308, the transceiver 310, the modem 312, and the one or more antennas 316, to execute the steps of method 900. Further, a wireless communication device such as the base station (BS) 105 or BS 400 of FIG. 4 may utilize one or more components, such as the processor 402, the memory 404, the HARQ module 408, the transceiver 410, the modem 412, and the one or more antennas 416, to execute the steps of method 900. The method 900 may employ similar mechanisms as described in FIGS. 1-8.

As illustrated in FIG. 9, step 910 includes determining, by a first wireless communication device, a starting hybrid automatic repeat request (HARQ) process identifier (ID) for HARQ processes for communicating in a configured grant resource including a number of slots N, each slot of the N number of slots including a number of physical uplink shared channels (PUSCHs) M, and a repetition factor K, wherein N, M, and K are integers greater than or equal to one (1). In some aspects, each of network 100, BS 105/400, and UE 114/300 may perform the determining step 910 using one or more of a processor, memory, and/or software, including, for example, the hardware and software components illustrated in FIGS. 1 and 3-4. Various algorithms may be used by each entity to perform this step, including, for example, basing the starting HARQ ID on: a factor L where L is based on M*N/K, ceiling(M*N/K), or floor(M*N/K), the current symbol, a periodicity of the configured grant resource, and/or the algorithms described above with respect to FIGS. 5-9.

Step 920 further includes communicating, by the first wireless communication device with a second wireless communication device, a first communication associated with the determined starting HARQ process ID. In some aspects, each of network 100, BS 105/400, and UE 114/300 may perform the communicating step 920 using one or more of a processor, memory, software, and/or a transceiver, including, for example, the hardware and software components illustrated in FIGS. 1 and 3-4. Various algorithms may be used by each entity to perform this step, including, for example, wireless radio transmission algorithms based on CDMA, TDMA, FDMA, OFDMA, SC-FDMA, GSM, UMTS, LTE, 5G, and/or NR technology. In some aspects, communicating can include receiving, by a first wireless communication device (e.g., BS 105/400), a TB on a PUSCH associated with a determined starting HARQ process ID. In some instances, communicating can include transmitting, by a first wireless communication device (e.g., UE 115/300), a TB on a PUSCH associated with a determined starting HARQ process ID.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1. A method of wireless communication, comprising:
determining, by a first wireless communication device, a starting hybrid automatic repeat request (HARQ) process identifier (ID) for HARQ processes for communicating in a configured grant resource including a number of slots N, each slot of the N number of slots including a number of physical uplink shared channels (PUSCHs) M, and a repetition factor K, wherein N, M, and K are integers greater than or equal to one (1); and
communicating, by the first wireless communication device with a second wireless communication device, a first communication associated with the determined starting HARQ process ID.

2. The method of claim 1, wherein the communicating the communication further comprises:
communicating, by the first wireless communication device, the communication in a frequency band located within a licensed spectrum.

3. The method of claim 1, further comprising:
communicating, by the first wireless communication device, a communication for each HARQ process in a subset of the HARQ processes in the configured grant resource,
wherein a beginning communication in the configured grant resource corresponds to the first communication, and
wherein the subset of the HARQ processes includes a number of subset HARQ processes L each identified by one of a number of HARQ process IDs L.

4. The method of claim 3, wherein L is based on N*M/K,
wherein a number of the HARQ processes Y is an integer multiple of the number of subset HARQ processes L,
wherein a periodicity of the configured grant resource is P, wherein P is an integer greater than or equal to one (1),
wherein a current symbol S is a beginning symbol of a beginning slot of the N number of slots in the configured grant resource, and
wherein the determining the starting HARQ process ID further includes basing the starting HARQ process ID on {[floor(S/P)]modulo[Y/L]}*L.

5. The method of claim 4, wherein J is an integer with the values J=0, 1, . . . , L-1, and
wherein each of the number of HARQ process IDs L is based on [(starting HARQ process ID)+J]modulo[Y].

6. The method of claim 3, wherein the configured grant resource has a first periodicity,
wherein the determining the starting HARQ process ID further includes basing the starting HARQ process ID on a second periodicity that is a multiple of the first periodicity, and
wherein the second periodicity is based on a number of the HARQ processes Y not being an integer multiple of L.

7. The method of claim 3, wherein L is based on N*M/K,
wherein a number of the HARQ processes Y is not an integer multiple of the number of subset HARQ processes L,
wherein a periodicity of the configured grant resource is P, wherein P is an integer greater than or equal to one (1),
wherein a current symbol S is a beginning symbol of a beginning slot of the N number of slots in the configured grant resource, and
wherein the determining the starting HARQ process ID further includes basing the starting HARQ process ID on [floor(S/P/Y)]modulo[Y*L].

8. The method of claim 7, wherein J is an integer with the values J=0, 1, . . . , L*Y-1, and
wherein each of the number of HARQ process IDs L is based on [(starting HARQ process ID)+J]modulo[Y].

9. The method of claim 3, wherein the communicating the communication for each of the number of subset HARQ processes L further comprises:
communicating, by the first wireless communication device, a last communication in the configured grant resource with less than K repetitions based on a total number of PUSCHs in the configured grant resource not being an integer multiple of K.

10. The method of claim 9, wherein M*N is not an integer multiple of K,
wherein the number of subset HARQ processes L is based on ceiling(M*N/K),
wherein a transport block is associated with each of the number of subset HARQ processes L,
wherein the transport block associated with each of the first L-1 of the number of subset HARQ processes L has K repetitions, and
wherein the transport block associated with each of the remaining HARQ processes of the number of subset HARQ processes L has M*N-K*(L-1) repetitions.

11. The method of claim 3, wherein the communicating the communication for each of the number of subset HARQ processes L further comprises:
communicating, by the first wireless communication device, one or more communications in the configured grant resource based on a second repetition factor,
wherein the second repetition factor is based on a total number of PUSCHs in the configured grant resource not being an integer multiple of K.

12. The method of claim 11, wherein M*N is not an integer multiple of K,
wherein L is based on ceiling(M*N/K),
wherein a transport block is associated with each of the number of subset HARQ processes L,
wherein the transport block associated with each of the first L-M*N+floor(M*N/L)*L of the number of subset HARQ processes L has floor(M*N/L) repetitions, and
wherein the transport block associated with each of the remaining M*N-floor(M*N/L)*L of the number of subset HARQ processes L has floor(M*N/L)+1 repetitions.

13. The method of claim 3, wherein the communicating the communication for each of the number of subset HARQ processes L further comprises:
communicating, by the first wireless communication device, the communication for each of the number of subset HARQ processes L in the configured grant resource with K or more repetitions based on the repetition factor K.

14. The method of claim 13, wherein the communicating the communication for each of the number of subset HARQ processes L further comprises:
communicating a last communication in the configured grant resource with greater than K repetitions based on a total number of PUSCHs in the configured grant resource not being an integer multiple of K.

15. The method of claim 14, wherein M*N is not an integer multiple of K,
wherein L is based on floor(M*N/K),
wherein a transport block is associated with each of the number of subset HARQ processes L,
wherein the transport block associated with each of the first L-1 of the number of subset HARQ processes L has K repetitions, and
wherein the transport block associated with each of the remaining of the number of subset HARQ processes L has M*N-K*(L-1) repetitions.

16. The method of claim 1, wherein the communicating the communication further comprises:
receiving, by the first wireless communication device, the communication on a physical uplink shared channel (PUSCH) associated with the starting HARQ process ID.

17. The method of claim 1, wherein the communicating the communication further comprises:
transmitting, by the first wireless communication device, the communication on a physical uplink shared channel (PUSCH) associated with the starting HARQ process ID.

18. A first wireless communication device, comprising:
a processor configured to:
determine a starting hybrid automatic repeat request (HARQ) process identifier (ID) for HARQ processes for communicating in a configured grant resource including a number of slots N, each slot of the N number of slots including a number of physical uplink shared channels (PUSCHs) M, and a repetition factor K, wherein N, M, and K are integers greater than or equal to one (1); and
a transceiver configured to:
communicate, with a second wireless communication device, a first communication associated with the determined starting HARQ process ID.

19. The first wireless communication device of claim 18, wherein the transceiver is further configured to:
communicate the communication in a frequency band located within a licensed spectrum.

20. The first wireless communication device of claim 18, wherein the transceiver is further configured to:
communicate a communication for each HARQ process in a subset of the HARQ processes in the configured grant resource,
wherein a beginning communication in the configured grant resource corresponds to the first communication, and
wherein the subset of the HARQ processes includes a number of subset HARQ processes L each identified by one of a number of HARQ process IDs L.

21-25. (canceled)

26. The first wireless communication device of claim 20, wherein the transceiver is further configured to:
communicate a last communication in the configured grant resource with less than K repetitions based on a total number of PUSCHs in the configured grant resource not being an integer multiple of K.

27. (canceled)

28. The first wireless communication device of claim 20, wherein the transceiver is further configured to:
communicate one or more communications in the configured grant resource based on a second repetition factor,
wherein the second repetition factor is based on a total number of PUSCHs in the configured grant resource not being an integer multiple of K.

29. (canceled)

30. The first wireless communication device of claim 20, wherein the transceiver is further configured to:
communicate the communication for each of the number of subset HARQ processes L in the configured grant resource with K or more repetitions based on the repetition factor K.

31. The first wireless communication device of claim 30, wherein the transceiver is further configured to:
communicate a last communication in the configured grant resource with greater than K repetitions based on a total number of PUSCHs in the configured grant resource not being an integer multiple of K.

32. (canceled)

33. The first wireless communication device of claim 18, wherein the transceiver is further configured to:
receive the communication on a physical uplink shared channel (PUSCH) associated with the starting HARQ process ID.

34. The first wireless communication device of claim 18, wherein the transceiver is further configured to:
transmit the communication on a physical uplink shared channel (PUSCH) associated with the starting HARQ process ID.

35. A non-transitory computer-readable medium having program code recorded thereon, the program code, when executed by a processor in a first wireless communication device, comprising code for causing the first wireless communication device to:
determine a starting hybrid automatic repeat request (HARQ) process identifier (ID) for HARQ processes for communicating in a configured grant resource including a number of slots N, each slot of the N number of slots including a number of physical uplink shared channels (PUSCHs) M, and a repetition factor K, wherein N, M, and K are integers greater than or equal to one (1); and
communicate, with a second wireless communication device, a first communication associated with the determined starting HARQ process ID.

36-51. (canceled)

52. A first wireless communication device, comprising:
means for determining a starting hybrid automatic repeat request (HARQ) process identifier (ID) for HARQ processes for communicating in a configured grant resource including a number of slots N, each slot of the N number of slots including a number of physical uplink shared channels (PUSCHs) M, and a repetition factor K, wherein N, M, and K are integers greater than or equal to one (1); and
means for communicating, with a second wireless communication device, a first communication associated with the determined starting HARQ process ID.

53. The first wireless communication device of claim 52, wherein the means for communicating the communication includes:
means for communicating the communication in a frequency band located within a licensed spectrum.

54. The first wireless communication device of claim 52, further comprising:
means for communicating a communication for each HARQ process in a subset of the HARQ processes in the configured grant resource,
wherein a beginning communication in the configured grant resource corresponds to the first communication, and
wherein the subset of the HARQ processes includes a number of subset HARQ processes L each identified by one of a number of HARQ process IDs L.

55-59. (canceled)

60. The first wireless communication device of claim 54, wherein the means for communicating the communication for each of the number of subset HARQ processes L includes:
means for communicating a last communication in the configured grant resource with less than K repetitions based on a total number of PUSCHs in the configured grant resource not being an integer multiple of K.

61. (canceled)

62. The first wireless communication device of claim 54, wherein the means for communicating the communication for each of the number of subset HARQ processes L includes:
means for communicating one or more communications in the configured grant resource based on a second repetition factor,
wherein the second repetition factor is based on a total number of PUSCHs in the configured grant resource not being an integer multiple of K.

63. (canceled)

64. The first wireless communication device of claim 54, wherein the means for communicating the communication for each of the number of subset HARQ processes L includes:
means for communicating the communication for each of the number of subset HARQ processes L in the configured grant resource with K or more repetitions based on the repetition factor K.

65. The first wireless communication device of claim 64, wherein the means for communicating the communication for each of the number of subset HARQ processes L includes:
means for communicating a last communication in the configured grant resource with greater than K repetitions based on a total number of PUSCHs in the configured grant resource not being an integer multiple of K.

66-67. (canceled)

68. The first wireless communication device of claim 52, wherein the means for communicating the communication further comprises:
means for transmitting the communication on a physical uplink shared channel (PUSCH) associated with the starting HARQ process ID.
